(19) United States
(12) Patent Application Publication
(10) Pub. No.: US 2013/0307987 A1
(43) Pub. Date: Nov. 21, 2013

(54) ELECTRONIC DEVICE AND METHOD FOR UNLOCKING ELECTRONIC LOCK

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: WEN-DONG LUO, Shenzhen (CN); CHIA-HUNG CHIEN, New Taipei (TW); TSUNG-JEN CHUANG, New Taipei (TW)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/873,257

(22) Filed: Apr. 30, 2013

(30) Foreign Application Priority Data
May 21, 2012 (CN) 2012101579493

(51) Int. Cl. G07C 9/00

(52) U.S. Cl. CPC G07C 9/00174
USPC 348/156

(57) ABSTRACT

The disclosure relates to an electronic device and a method of unlocking an electronic lock for the device. The device defines an open mode and stores a first image, the first image is divided into a first plurality of bocks one of which is selected as an electronic key. The device includes a transmitter and a receiver communicated with the transmitter via wireless and connected with the electronic lock via wire. The method includes: when the device enters the open mode, capturing a second image; dividing the second image into a second plurality of blocks in response to user inputs; selecting one of the second plurality of blocks in response to user inputs; determining whether the selected block of the second image is similar to the selected block of the first image; and if yes, sending a control signal to control the receiver to unlock the electronic lock.

### BACKGROUND

1. Technical Field

The disclosure relates to an electronic device and, more particularly, to an electronic device for unlocking an electronic lock and an unlocking electronic lock method adapted for the electronic device.

2. Description of Related Art

A lot of locks need a physical key to open, however, carrying the physical key is very inconvenient, and if the user loses the key, he will have to go through troubles in getting the lock unlocked.

Use of electronic locks can avoid problems of carrying a physical key. Therefore, what is needed is an electronic device for unlocking electronic lock.

### BRIEF DESCRIPTION OF THE DRAWINGS

FIG. 1 is a block diagram of an electronic device in accordance with an exemplary embodiment.

FIG. 2 is a block diagram of a first control unit of the electronic device of FIG. 1.

FIG. 3 is a block diagram of a second control unit of the electronic device of FIG. 1.

FIGS. 4A-4B is a flowchart of a method of unlocking an electronic lock adapted for the electronic device of FIG. 1.

### DETAILED DESCRIPTION

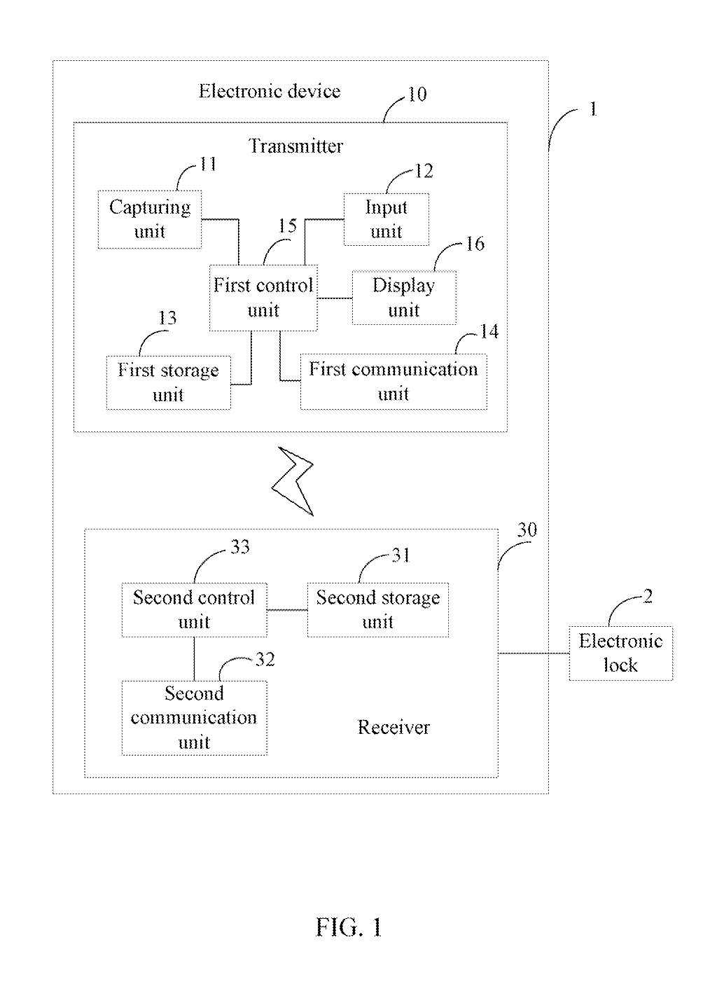

FIG. 1 is a block diagram of an electronic device 1 in accordance with an exemplary embodiment. The electronic device 1 includes a transmitter 10 and a receiver 30. The transmitter 10 communicates with the receiver 30 wirelessly, such as BLUETOOTH. The transmitter 10 includes a capturing unit 11, an input unit 12, a first storage unit 13, a first communication unit 14, a first control unit 15, and a display unit 16. The capturing unit 11 captures an image in front of the electronic device 1, for example, the capturing unit 11 is a camera. The input unit 12 generates input signals in response to user inputs. The first storage unit 13 stores data, for example, the first storage unit 13 stores images. The first communication unit 14 sends wireless signals to the receiver 30 and receives wireless signals from the receiver 30. The first control unit 15 controls the transmitter 10. The display unit 16 displays information, such as an image, for example.

The receiver 30 is connected with an electronic lock 2 via wire. The receiver 30 includes a second storage unit 31, a second communication unit 32, and a second control unit 33. The second storage unit 31 stores data, for example, the second storage unit 31 stores images. The second communication unit 32 sends and receives wireless signals to and from the transmitter 10. The second control unit 33 controls the receiver 30.

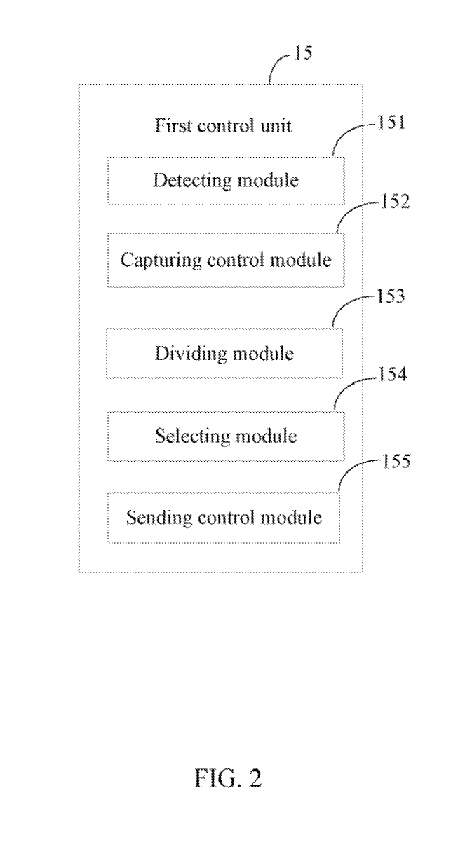

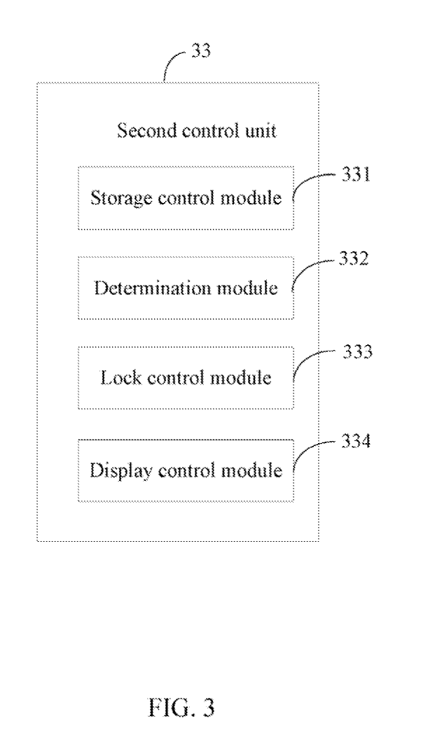

FIG. 2 shows the first control unit 15 further includes a detecting module 151, a capturing control module 152, a dividing module 153, a selecting module 154, and a sending control module 155. FIG. 3 shows the second control unit 33 further includes a storage control module 331, a determination module 332, a lock control module 333, and a display control module 334.

The electronic device 1 defines a setting mode and an open mode. In the setting mode, a user can set a key for unlocking the electronic lock 2. In the open mode, the user can unlock the electronic lock 2 by the key. The detecting module 151 detects that the electronic device 1 enters the setting mode or the open mode in response to user inputs from the input unit 12. For example, the input unit 12 is a keyboard, when the user presses a first key in the keyboard, the detecting module 151 detects that the electronic device 1 enters the setting mode; when the user presses a second key in the keyboard, the detecting module 151 detects that the electronic device 1 enters the open mode. When the electronic device 1 is utilized for the first time or the user wants to change an electronic key of the electronic lock 2, the electronic device 1 enters the setting mode. When the electronic device 1 is in use, the electronic device 1 enters the open mode.

When the detecting module 151 detects that the electronic device 1 enters the setting mode, the capturing control module 152 captures a first image and the dividing module 153 divides the first image into a first number of blocks in response to user inputs from the input unit 12, for example, the first image is divided into nine blocks, wherein each block is associated with a sub-image. The selecting module 154 selects one of the first number of blocks in response to user inputs, for example, a third block from the nine blocks is selected. The sending control module 155 acquires the selected block of the first image and controls the first communication unit 14 to send the selected block of the first image and a first control signal.

The second communication unit 32 receives the selected block of the first image and the first control signal. The storage control module 331 stores the selected block of the first image in the second storage unit 31 and sets the selected block of the first image as the electronic key of the electronic lock 2 in response to the first control signal.

When the detecting module 151 detects that the electronic device 1 enters the open mode, the capturing control module 152 captures a second image and the dividing module 153 divides the second image into a second number of blocks in response to inputs from a user on the input unit 12. The selecting module 154 selects one of the second number of blocks in response to the inputs from a user on the input unit 12. The sending control module 155 acquires the selected block of the second image and controls the first communication unit 14 to send the selected block of the second image and a second control signal.

The second communication unit 32 receives the selected block of the second image and the second control signal. The determination module 332 determines whether the selected block of the second image is similar to the selected block of the first image. For example, the determination module 332 determines whether a similarity between the selected block of the second image and the selected block of the first image is greater than 90%. When the similarity is greater than 90%, that means that the selected block of the second image is similar to the selected block of the first image; and when the similarity is less than 90%, that means that the selected block of the second image is not similar to the selected block of the first image.

When the determination module 332 determines that the selected block of the second image is similar to the selected block of the first image, that means that the user is a legal one, the lock control module 333 unlocks the electronic lock 2 in response to the second control signal. When the determination module 332 determines that the selected block of the second image is not similar to the selected block of the first image, that means that the user is an illegal one, the lock control module 333 generates a fail prompt and the display control module 334 controls the display unit 16 to display the fail prompt.

In another embodiment, the storage control module 331 is embedded into the first control unit 15 and both the first image and the selected block of the first image is stored in the first storage unit 13. The first control unit 15 determines whether the selected block of the second image is similar to the selected block of the first image. When the selected block of the second image is similar to the selected block of the first image, the first control unit 15 sends the second control signal to control the receiver 30 to unlock the electronic lock 2.

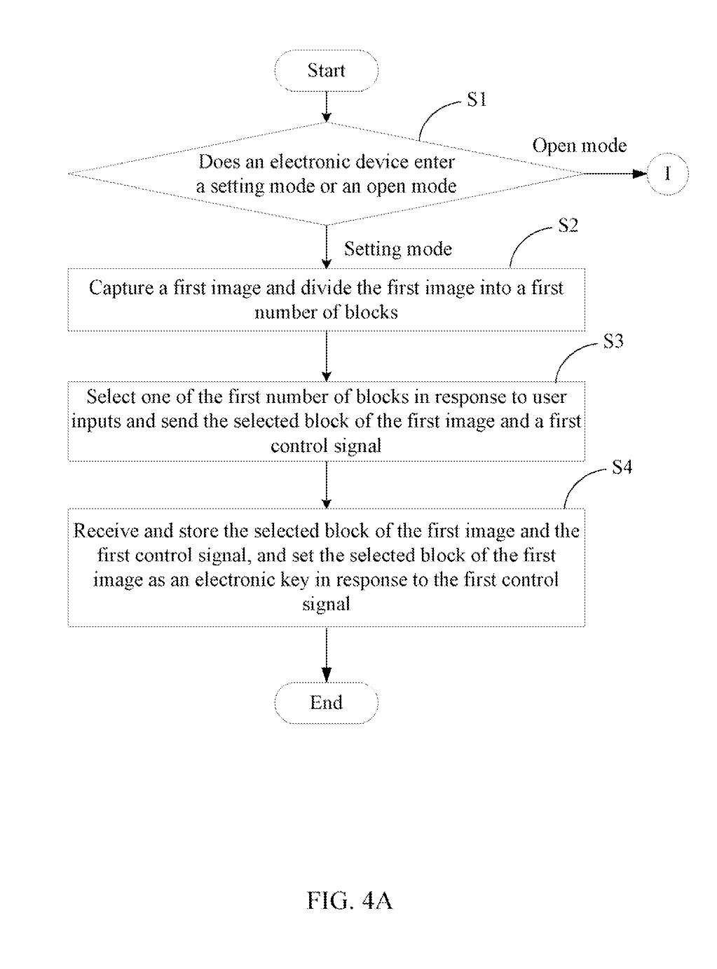

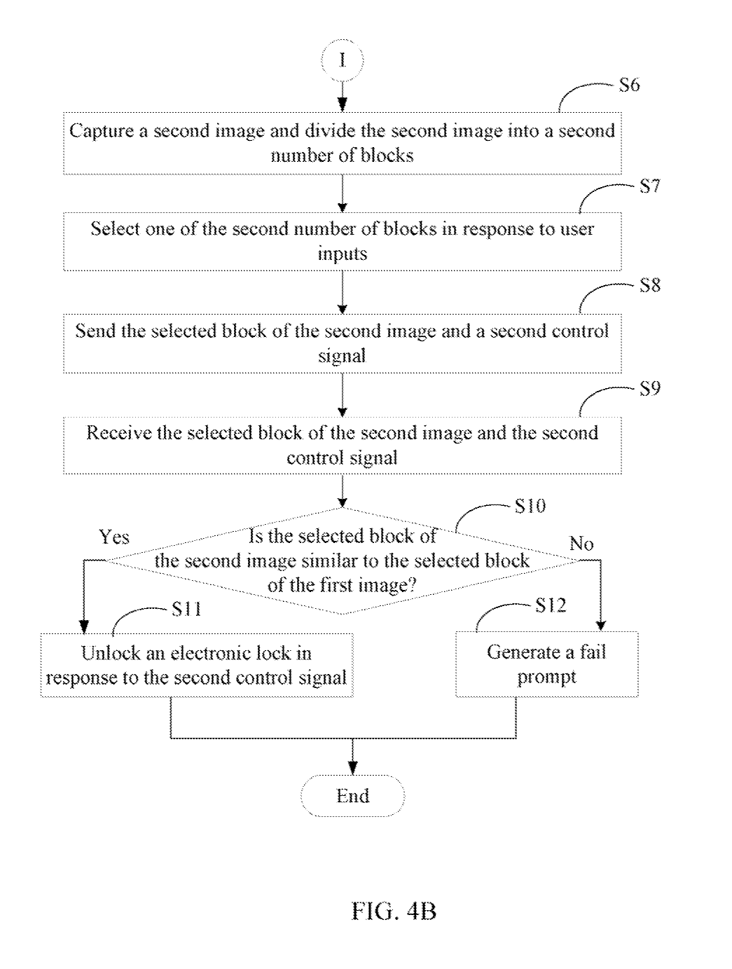

FIGS. 4A-4B is a flowchart of a method of unlocking electronic lock 2 adapted for the electronic device 1 of FIG. 1. In step S1, the detecting module 151 detects that the electronic device 1 enters the setting mode or the open mode in response to user inputs from the input unit 12. When the detecting module 151 detects that the electronic device 1 enters the setting mode, the flowchart goes to step S2. When the detecting module 151 detects that the electronic device 1 enters the open mode, the flowchart goes to step S6.

In step S2, when the detecting module 151 detects that the electronic device 1 enters the setting mode, the capturing control module 152 captures a first image and the dividing module 153 divides the first image into a first number of blocks in response to user inputs from the input unit 12.

In step S3, the sending control module 155 acquires the selected block of the first image and controls the first communication unit 14 to send the selected block of the first image and a first control signal.

In step S4, the second communication unit 32 receives the selected block of the first image and the first control signal, the storage control module 331 stores the selected block of the first image in the second storage unit 31 and sets the selected block of the first image as the electronic key of the electronic lock 2 in response to the first control signal.

In step S6, when the detecting module 151 detects that the electronic device 1 enters the open mode, the capturing control module 152 captures a second image and the dividing module 153 divides the second image into a second number of blocks in response to user inputs from the input unit 12.

In step S7, the selecting module 154 selects one of the second number of blocks in response to user inputs.

In step S8, the sending control module 155 acquires the selected block of the second image and controls the first communication unit 14 to send the selected block of the second image and a second control signal.

In step S9, the second communication unit 32 receives the selected block of the second image and the second control signal.

In step S10, the determination module 332 determines whether the selected block of the second image is similar to the selected block of the first image.

In step S11, when the determination module 332 determines that the selected block of the second image is similar to the selected block of the first image, the lock control module 333 unlocks the electronic lock in response to the second control signal.

In step S12, when the determination module 332 determines that the selected block of the second image is not similar to the selected block of the first image, the lock control module 333 generates a fail prompt and the display control module 334 controls the display unit 16 to display the fail prompt.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device for unlocking an electronic lock, wherein the electronic device defines an open mode, the electronic device comprising:
a storage unit to store a first image, the first image being divided into a first plurality of blocks one of which is selected as an electronic key;
a transmitter;
a receiver communicated with the transmitter via wireless and connected with the electronic lock via wire; and
a first control unit;
the transmitter comprising:
a capturing unit to capture images;
an input unit;
a second control unit to control the capturing unit to capture a second image when the electronic device enters the open mode, divide the second image into a second plurality of blocks in response to user inputs from the input unit, and select one of the second plurality of blocks in response to user inputs; and
the first control unit to determine whether the selected block of the second image is similar to the selected block of the first image, and send a control signal to control the receiver to unlock the electronic lock when the selected block of the second image is similar to the selected block of the first image.

2. The electronic device as recited in claim 1, wherein when the selected block of the second image is not similar to the selected block of the first image, the first control unit generates a fail prompt.

3. The electronic device as recited in claim 1, wherein the first image is stored in the transmitter, the first control unit is replaced by the second control unit.

4. The electronic device as recited in claim 1, wherein the first image is stored in the receiver, the first control unit is replaced by the receiver, the receiver is configured to determine whether the selected block of the second image is similar to the selected block of the first image, and send the control signal to unlock the electronic lock when the selected block of the second image is similar to the selected block of the first image.

5. The electronic device as recited in claim 1, wherein the electronic device defines a setting mode, when the electronic device enters the setting mode, the second control unit is configured to control the capturing unit to capture the first image when the electronic device enters the setting mode, divide the first image into the first plurality of blocks in response to user inputs from the input unit, select one of the first plurality of blocks in response to user inputs, and store the selected block of the first image as the electronic key in the storage unit.

6. The electronic device as recited in claim 1, wherein the storage unit is embedded into the transmitter.

7. The electronic device as recited in claim 1, wherein the storage unit is embedded into the receiver.

8. A method of unlocking electronic lock for an electronic device, wherein the electronic device defines an open mode, the electronic device stores a first image, the first image is divided into a first plurality of bocks one of which is selected as an electronic key, and the electronic device comprises a transmitter and a receiver communicated with the transmitter via wireless and connected with the electronic lock via wire, the method comprising:
when the electronic device enters the open mode, capturing a second image;
dividing the second image into a second plurality of blocks in response to user inputs;
selecting one of the second plurality of blocks in response to user inputs;
determining whether the selected block of the second image is similar to the selected block of the first image; and
if the selected block of the second image is similar to the selected block of the first image, sending a control signal to control the receiver to unlock the electronic lock.

9. The method as recited in claim 8, further comprising:
if the selected block of the second image is not similar to the selected block of the first image, generating a fail prompt.

10. The method as recited in claim 8, wherein the first image is stored in the transmitter.

11. The method as recited in claim 8, wherein the first image is stored in the receiver.

12. The method as recited in claim 8, wherein the electronic device defines a setting mode, the method further comprises:
when the electronic device enters the setting mode, capturing the first image;
dividing the first image into the first plurality of blocks in response to user inputs; and
selecting one of the first plurality of blocks in response to user inputs and storing the selected block of the first image as the electronic key.
